(19) United States
(12) Patent Application Publication
(10) Pub. No.: US 2025/0361102 A1
(43) Pub. Date: Nov. 27, 2025

(54) FLEXIBLE MANUFACTURING SYSTEM AND ROTOR FOR SUCH A FLEXIBLE MANUFACTURING SYSTEM

(71) Applicant: Beckhoff Automation GmbH, Verl (DE)

(72) Inventors: Daniel Golz, Langenberg (DE); Michael Golz, Bielefeld (DE)

(21) Appl. No.: 19/293,376

(22) Filed: Aug. 7, 2025

Related U.S. Application Data
(63) Continuation of application No. PCT/EP2024/055119, filed on Feb. 28, 2024.

(30) Foreign Application Priority Data
Mar. 7, 2023 (DE) 10 2023 105 599.2

(51) Int. Cl. B65G 54/02

(52) U.S. Cl. CPC B65G 54/02

(57) ABSTRACT

A flexible manufacturing system having a manufacturing platform, on which a transport device and a plurality of processing stations are arranged, comprises a controller. During the processing of a workpiece at the processing station with a projecting frame, the controller is configured to move a rotor of the transport device with the workpiece located in a receiving tray via control signals on a network of the plurality of stator modules of the transport device in such a way that the projecting frame of the transport device is moved via control signals, so that the projecting frame of the processing station engages with the receiving tray to lift the receiving tray from longitudinal recesses on L-shaped side-pieces or cheeks of the frame of the workpiece holder before the workpiece is processed by the tool of the processing station.

### CROSS-REFERENCE TO RELATED APPLICATIONS

This patent application is a continuation of International Patent Application No. PCT/EP2024/055119, filed Feb. 28, 2024, entitled “Flexible Manufacturing System and rotor for such a Flexible Manufacturing System,” which claims priority to German Patent Application No. DE 10 2023 105 599.2, entitled “Flexibles Fertigungssystem und Läufer für ein solches flexibles Fertigungssystem,” filed Mar. 7, 2023, each of which is incorporated by reference herein, in the entirety and for all purposes.

### TECHNICAL FIELD

The invention relates to a flexible manufacturing system and to a rotor for such a flexible manufacturing system.

### BACKGROUND

Flexible manufacturing systems are multi-machine systems for processing workpieces. The individual processing stations are in this context interlinked via a transport system to allow for an automated workpiece flow.

Inter alia, planar drive systems comprising an electromagnetic planar motor having a planar stator assembly and a rotor that may move on the stator assembly are used as transport device in flexible manufacturing systems. DE 10 2017 131 304 A1 discloses a planar drive system in which a transport level consists of a composite of stator modules, each stator module comprising a stator module housing having a stator surface and a coil arrangement arranged below the stator surface for generating a stator magnetic field. The stator modules are embodied to energize the coil arrangement in accordance with the control signals of a controller connected to the stator module network in order to move the rotors, each of which comprising a plate-shaped rotor housing with a permanent magnet arrangement for generating a rotor magnetic field, on the transport level. The rotors are freely movable in in parallel with regard to the transport level with the aid of the interaction of the stator magnetic field and the rotor magnetic field and may also carry out movements perpendicular with regard to the transport level within a limited distance range with regard to the transport level, so that the rotors may be moved with high precision in the direction of all six rigid-body-degrees of freedom.

DE 10 2019 117 431 A1 discloses a planar drive system comprising a processing station. However, if a workpiece transported on a rotor is to be processed directly on the rotor itself by a tool of the processing station, the action of the tool of the processing station during processing of the workpiece arranged on the rotor may mean that the planar motor forces and torques are not sufficient to counteract the loads on the rotor caused during processing of the workpiece, so that the rotor then unintentionally strikes the stator surface and may damage it in the process. Damage to the structure of the stator may also occur when the rotor is lowered onto the stator surface if high process forces act upon the workpiece and thus upon the rotor. Furthermore, the structure of the rotor itself may be damaged.

EP 43 904 248 A1 discloses support structures arranged at the processing stations for the rotors in a planar drive system, which counteract the loads on the rotor with a supporting force during the processing of a workpiece transported on a rotor by a tool of a processing station. The rotor may be moved into and out of the support position with the aid of the stator assembly of the planar motor.

### SUMMARY

The invention provides a flexible manufacturing system comprising a planar motor as a transport device and a rotor for such a flexible manufacturing system, which allow for variable workpiece processing.

According to a first aspect, a flexible manufacturing system includes a manufacturing platform on which a transport device and a plurality of processing stations are arranged, and a controller. The transport device comprises a plurality of stator modules and at least one rotor for transporting workpieces, wherein each stator module comprises a stator module housing having a stator surface and a coil arrangement arranged below the stator surface for generating a stator magnetic field, wherein the rotor comprises a plate-shaped rotor housing having a permanent magnet arrangement for generating a rotor magnetic field and a workpiece holder arranged on the rotor housing.

The workpiece holder comprises a frame having two L-shaped side-pieces or “cheeks” and a receiving tray having an inner shape for inserting a workpiece, wherein each L-shaped cheek comprises a first arm for fastening to the plate-shaped rotor housing and a second arm projecting from the first arm and oriented substantially in parallel with regard to the plate-shaped rotor housing, wherein the second arms of the L-shaped cheeks each comprise opposite longitudinal recesses for laterally supporting the receiving tray. The plurality of stator modules on the manufacturing platform embody a compound having a transport level formed by the stator surfaces for linking the processing stations arranged adjacent to the transport level.

The controller is configured to output control signals to the network of the plurality of stator modules and the stator modules are configured to energize the coil groups of the associated stator assemblies in accordance with the control signals to move the rotor on the transport level to the processing stations, wherein the rotor may be moved above the transport level in a first direction and/or a second direction and/or a third direction with the aid of the interaction of the stator field and the rotor magnetic field, wherein the first direction and the second direction are oriented in parallel with regard to the transport level and the third direction is oriented perpendicular with regard to the transport level. Each processing station comprises a tool for processing the workpiece in the receiving tray of the workpiece holder of the rotor, wherein at least one processing station comprises a frame projecting beyond the transport level for depositing the receiving tray of the workpiece holder of the rotor.

The controller is embodied to move the rotor with a workpiece located in the receiving tray with the aid of control signals on the network of the plurality of stator modules during the processing of the workpiece at the processing station with the projecting frame in such a way that the projecting frame of the processing station engages with the receiving tray supported by the second arms of the L-shaped cheeks of the frame of the workpiece holder in order to lift the receiving tray out of the longitudinal recesses of the second arms of the L-shaped cheeks of the frame of the workpiece holder before the processing of the workpiece with the aid of the tool of the processing station.

According to a second aspect, a rotor for a flexible manufacturing system is provided. The flexible manufacturing system including a transport device comprises a plurality of stator modules and at least one rotor for transporting workpieces. The rotor comprises a plate-shaped rotor housing with a permanent magnet arrangement for generating a rotor magnetic field and a workpiece holder arranged at the rotor housing, wherein the workpiece holder includes a frame having two L-shaped cheeks and a receiving tray having an interior shape for inserting a workpiece, wherein each L-shaped cheek comprises a first arm for fastening on the plate-shaped rotor housing and a second arm projecting from the first arm, the second arm being essentially aligned in parallel with regard to the plate-shaped rotor housing, wherein the second arms of the L-shaped cheeks each comprise longitudinal recesses for lateral support of the receiving tray on opposite sides of each other.

According to a third aspect, A processing station for a flexible manufacturing system is provided. The flexible manufacturing system includes a manufacturing platform on which a transport device and a plurality of processing stations are arranged, wherein the transport device comprises a plurality of stator modules and at least one rotor for transporting workpieces, wherein the plurality of stator modules embody a compound having a transport level formed by the stator surfaces for linking the processing stations arranged adjacent to the transport level. The processing station comprises a tool for processing a workpiece in a receiving tray of a workpiece holder of the rotor, and a frame projecting beyond a transport level for depositing the receiving tray of the workpiece holder of the rotor.

### EXAMPLES

A flexible manufacturing system comprises a manufacturing platform on which a transport device and a plurality of processing stations are arranged, as well as a controller. The transport device comprises a plurality of stator modules and at least one rotor for transporting workpieces. Each stator module comprises a stator module housing having a stator surface and a coil arrangement arranged below the stator surface for generating a stator magnetic field.

The rotor comprises a plate-shaped rotor housing having a permanent magnet arrangement for generating a rotor magnetic field and a workpiece holder arranged on the rotor housing. The workpiece holder comprises a frame having two L-shaped cheeks and a receiving tray having an inner shape for inserting a workpiece. Each L-shaped cheek comprises a first arm for fastening to the plate-shaped rotor housing and a second arm projecting from the first arm and oriented substantially in parallel with regard to the plate-shaped rotor housing, wherein the second arms of the L-shaped cheeks each comprise opposite longitudinal recesses for laterally supporting the receiving tray. The plurality of stator modules on the manufacturing platform embodies a compound having a transport level formed from the stator surfaces for linking the processing stations, which are arranged adjacent to the transport level.

The controller is embodied to output control signals to the composite from the plurality of stator modules and the stator modules are embodied to energize the coil groups of the associated stator assemblies in accordance with the control signals in order to move the rotor on the transport level to the processing stations, the rotor being movable above the transport level in a first direction and/or a second direction and/or a third direction with the aid of the interaction of the stator field and of the rotor magnetic field, the first direction and the second direction being oriented in parallel with regard to the transport level and the third direction being oriented perpendicular with regard to the transport level.

Each processing station comprises a tool for processing the workpiece in the receiving tray of the workpiece holder of the rotor, wherein at least one processing station comprises a frame projecting above the transport level for depositing the receiving tray of the workpiece holder of the rotor. During processing of the workpiece at the processing station with the projecting frame, the controller is embodied to move the rotor with a workpiece located in the receiving tray with the aid of control signals on the network of the plurality of stator modules in such a way that the projecting frame of the processing station engages with the receiving tray supported by the second arms of the L-shaped cheeks of the frame of the workpiece holder, in order to lift the receiving tray out of the longitudinal recesses of the second arms of the L-shaped cheeks of the frame of the workpiece holder before the processing of the workpiece by the tool of the processing station.

The rotor comprising the workpiece holder may be precisely directed into a deposit position for the receiving tray comprising the workpiece on the projecting frame of the processing station, as the rotor is at its optimized floating level during positioning.

The projecting frame of the processing station may absorb the process forces and torques on the workpiece during processing by the tool of the processing station after it has been placed in the receiving tray with the workpiece, when the receiving tray of the workpiece holder of the rotor is lifted from the workpiece holder and positioned on the projecting frame of the processing station, in order to prevent the process forces and torques from acting on the rotor or on the stator surface.

In particular, process forces may be forces generated by a tool, such as clamping forces, forces applied to deform workpieces, forces that act on a workpiece during processing, contact forces, etc. Process torques introduced by the tool may be the attachment of screwable elements such as screws, nuts or screw caps, for example when closing containers such as bottles, or processing with a rotating tool, for example during drilling, milling, grinding or cutting.

The controller of the flexible manufacturing system may also be embodied to move the rotor comprising the workpiece holder and the workpiece located in the receiving tray with the aid of control signals on the composite of the plurality of stator modules in such a way that the rotor is guided laterally past the processing station, which comprises the frame projecting above the transport level, wherein the projecting frame projects into the free space between the rotor housing and the receiving tray supported laterally by the workpiece holder.

Due to the embodiment of the workpiece holder comprising the frame with the two L-shaped cheeks and the receiving tray, which is arranged on the second arms of the L-shaped cheeks, which are aligned essentially in parallel with regard to the plate-shaped rotor housing, the rotor may pass obstacles despite a raised structure, which protrude into the free space between the plate-shaped rotor housing and the receiving tray supported laterally by the workpiece holder. In particular, it is possible for the rotor to be guided laterally past the processing station with the frame projecting above the transport level without having to swerve.

It is possible to select different procedures depending on the process forces and torques on the workpiece during processing by the tool of the processing station. Particularly in the case of low process forces and torques on the workpiece during processing by the tool of the processing station, the controller may be embodied to keep the rotor in a floating state so that the degrees of freedom of the planar motor may continue to be used to change the positioning of the workpiece during workpiece processing. In terminal block manufacturing, for example, this procedure may be used to solder contacts on a circuit board.

The term “floating” in this context means that an air gap remains between the permanent magnet arrangement of the rotor and the stator surface of the stator module.

Particularly in the case of medium process forces and torques on the workpiece during processing by the tool of the processing station, the controller may be embodied to place the rotor onto the stator surface before processing. In terminal block production, this procedure is used, for example, to contact the lateral communication contacts, which are embodied as spring contacts, and thus load the terminal block software.

Particularly in the case of high process forces and torques on the workpiece during processing by the tool of the processing station, the controller may be embodied to place the frame and/or the receiving tray of the workpiece holder onto the projecting frame of the processing station before processing by lowering the rotor over the projecting frame. The projecting frame of the processing station may then fully absorb the process forces and torques during workpiece processing. In terminal block production, for example, this procedure may be used in a press in order to press the housing of the terminal block.

The projecting frame of the processing station may be embodied to move the deposited receiving tray. Due to the two-part embodiment of the workpiece holder consisting of the frame with the two L-shaped cheeks and the receiving tray having an inner shape for inserting a workpiece, the receiving tray with the workpiece may be released from the workpiece holder of the rotor in order to insert the receiving tray with the workpiece into a processing device. In terminal block production, for example, this procedure may be used to simultaneously contact and test the electrical contacts of the terminal block in a processing station.

The frame of the processing station projecting above the transport level may have a guide structure, for example a roller guide, which engages with the workpiece holder of the rotor and forces the rotor into the correct position. Once at the transfer position, the rotor is lowered or the receiving tray is lifted from the processing station and transfers the receiving tray of the workpiece carrier to the projecting frame of the processing station. The receiving tray may be centered by the outer shape and/or by a central rectangular cut-out into which a counterpart of the processing station engages.

A workpiece storage unit may also be provided on the manufacturing platform, which comprises a handling device for transferring the workpiece from the workpiece storage unit to the receiving tray or for transferring the workpiece from the receiving tray to the workpiece storage unit. This additional integration allows for achieving a flexible and fast workpiece flow.

The frame of the workpiece holder of the rotor may comprise a first and a second C-profile support, which are embodied as mirror images. The first and second C-profile supports each comprise a longitudinal beam, wherein an angled longitudinal recess is embodied in the upper edge area on the inside of the longitudinal beam. The receiving tray of the workpiece holder has C-shaped engagements on two opposite sides, wherein the upper engagement arm of the C-shaped engagement is embodied to engage in angled longitudinal recesses on the inside of the longitudinal beam

This embodiment makes it easy to remove the receiving tray from the frame between the first and second C-profile support by lifting and pulling it out of the frame of the workpiece holder.

A bevel is provided on the inside of the longitudinal beam underneath the longitudinal recess and on the outside of the C-shaped recesses of the receiving tray. The beveled contact surfaces make it easy to remove the receiving tray. Furthermore, the beveled contact surfaces allow for precise and reproducible positioning of the receiving tray in the workpiece holder and relative to the rotor.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A and 1B show a flexible manufacturing system, where FIG. 1A illustrates a perspective view and FIG. 1B a top view.

FIG. 2 shows a section of the transport device in the flexible manufacturing system from FIG. 1.

FIGS. 3A-3D show the rotor of the transport device from FIG. 2, where FIG. 3A shows an overall view and FIGS. 3B to 3D shows the components separately.

FIGS. 4A-4C show a section of the workpiece holder of the rotor from FIGS. 3A-3D, with FIG. 4A and FIG. 4B representing a first embodiment and FIG. 4C a second embodiment.

FIG. 5 shows a schematic cross-section of a type 1 processing station.

FIG. 6 shows a schematic cross-section of a type 2 processing station.

FIGS. 7A and 7B show schematic cross-sections of a type 3 processing station, where FIG. 7A illustrates a first embodiment and FIG. 7B a second embodiment.

FIG. 8 shows a section of the transport device in the flexible manufacturing system with a straight transport path.

FIGS. 9A-9D show a process with a type 3 processing station for terminal block production, in which the terminal block is fed into the processing station, with FIGS. 9A to 9D showing successively recorded snapshots of the process.

### DETAILED DESCRIPTION

Identical reference numerals are used for identical elements in the drawings. Furthermore, for reasons of clarity, it may be provided that not all elements are shown in every figure. Furthermore, for this reason, it may also be provided that not every element is assigned its own reference numeral in every drawing.

Terms that describe a spatial arrangement, such as “above”, “below”, “next to”, “to the side”, “horizontal”, “vertical”, “right”, “left”, each refer to the arrangement shown in the figure described. Such terms merely serve to facilitate the comprehensibility of the description and are not to be interpreted restrictively.

The invention is described using the example of a flexible manufacturing system that is used in the manufacture of electronic terminal blocks. Electronic terminal blocks are flat terminal blocks that may be arranged in a row on a mounting rail. Electronic terminal blocks wire analog and digital inputs and outputs. The main task of electronic terminal blocks is to bundle a large number of different sensor signals, for example from a machine or in a building, and to forward them to the controller via a standardized bus signal or to forward commands from the controller to the actuators.

Flexible manufacturing systems are multi-machine systems for processing workpieces, particularly in series production. The individual processing stations, usually numerically controlled machines, are interlinked via a transport system to allow for an automatic workpiece flow. In addition to the processing stations, a workpiece storage unit with a corresponding transfer station is provided. With flexible manufacturing systems, production processes may be easily configured to new requirements while maintaining high throughput times.

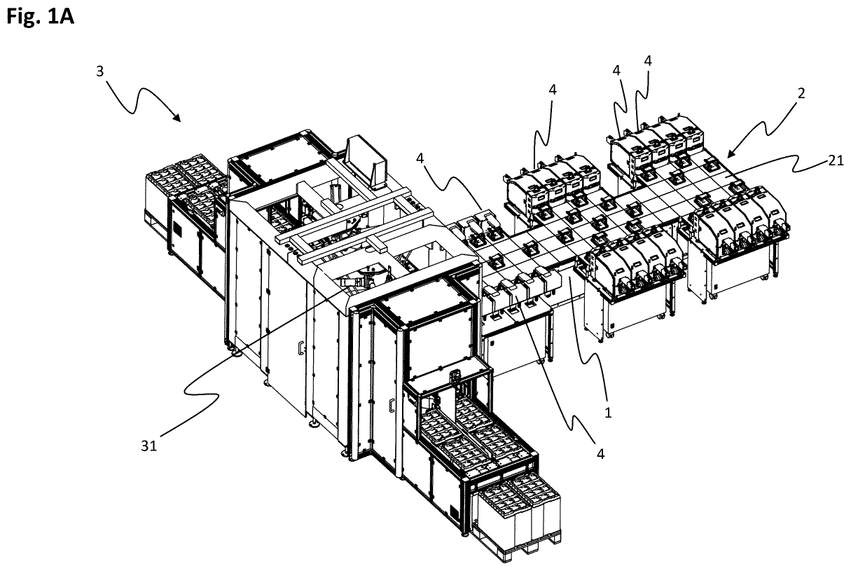

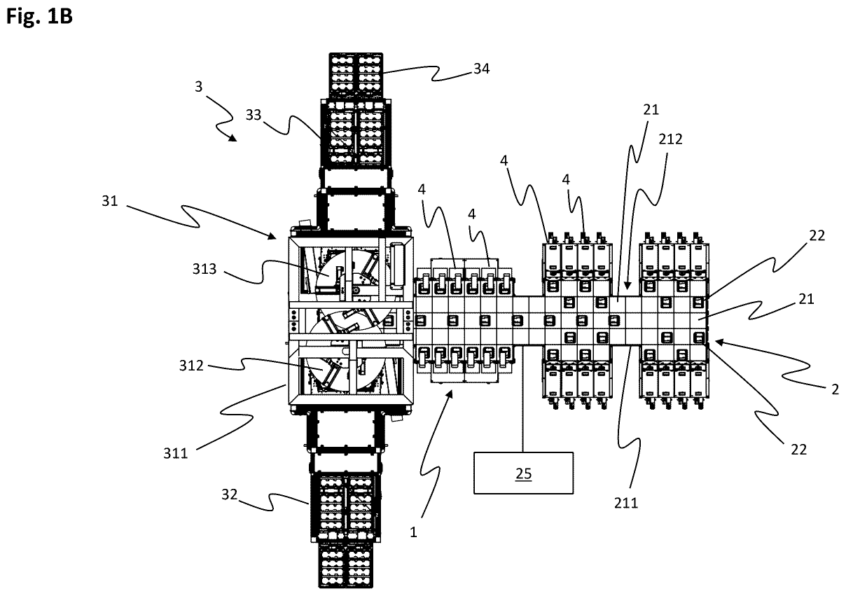

FIGS. 1A and 1B show a flexible manufacturing system for use in terminal block production. The flexible manufacturing system is shown in perspective in FIG. 1A and as a top view in FIG. 1B. The basis of the flexible manufacturing system is a rectangular manufacturing platform 1, on which a transport device 2, a workpiece storage 3 and a plurality of processing stations 4 are arranged.

The transport device 2 is embodied as a planar drive system and comprises a combination of stator modules 21 with square stator module housings 211. The stator surfaces 212 of the square stator module housings 211 form a closed transport level. In the embodiment shown in FIGS. 1A and 1B, the composite of square stator modules 21 is formed from three rows of stator modules 21, with additional stator modules being provided laterally in the area of the processing stations 4. Instead of a square stator module shape, other geometries are also possible, in particular those that may be combined to form a closed transport level. Furthermore, transport levels of any shape, for example square, rectangular, L-shaped or ring-shaped transport levels, may be realized by arranging the stator modules accordingly.

In the embodiment shown in FIG. 1, the workpiece storage unit 3 is located at the end of the transport level and comprises a handling device 31, which includes a support frame 311 that spans the three rows of stator modules 21 of the transport level and a first and second pick-and-place machine 312, 313 in the form of delta robots. Adjacent to the transport level, the workpiece storage unit 3 also comprises a first and second transport carrier 32, 33 for workpiece packs 34. In the embodiment shown in FIGS. 1A and 1B, the workpiece containers 34 are stackable pallets with inserts for terminal blocks. The lower first transport carrier 32 is used to feed pallets with prefabricated terminal blocks for further processing in the manufacturing system. The upper second transport carrier 33 is used to remove pallets with terminal blocks processed further in the manufacturing system.

The transport device 2 also comprises a plurality of rotors 22, which are movable on the transport level formed by the composite of the stator surfaces. The rotors 22 are used to transport workpieces, in the embodiment of terminal blocks shown in FIGS. 1A and 1B, between the workpiece storage 3 and the processing stations 4. The rotors 22 have a square plate-shaped rotor housing 221, on which a workpiece holder 23 is arranged. Instead of a square rotor housing shape, other geometries are also possible.

A coil arrangement for generating a stator magnetic field is provided in the stator module housing 211 of the stator modules 21 under the stator surface 212. The rotors 22 in turn have a permanent magnet arrangement in the plate-shaped rotor housing 221 for generating a rotor magnetic field. The stator modules 21 are connected to a controller 25 of the transport device 2. The controller 25 outputs control signals to the stator modules 21, where the stator modules 21 are embodied to energize the coil arrangement of the stator module in accordance with the control signals in order to move the rotors 22 on the transport level with the aid of the interaction of the stator magnetic field and the rotor magnetic field. The rotors 22 may be moved in parallel with regard to the transport level and may also carry out a movement perpendicular with regard to the transport level within a limited distance range, so that the rotors 22 may be moved in the direction of all six rigid body degrees of freedom.

In the embodiment shown in FIGS. 1A and 1B, the lower first pick-and-place machine 312 of the handling device 31 loads the rotors 22 by removing the prefabricated terminal blocks from the workpiece packs 34 and clamping them in the workpiece holders 222 of the rotors 22 positioned by the first pick-and-place machine 312. The upper second pick-and-place machine 313 then places the terminal blocks further processed by the processing stations 4, which the second pick-and-place machine 313 removes from the workpiece holders 222 of the carriers 22 positioned below the second pick-and-place machine 313, back into the workpiece containers 34.

In the embodiment shown in FIGS. 1A and 1B, the rotors 22 are controlled by the controller 25 in such a way that the two outer rows of stator modules serve as transport lines essentially for moving the rotors 22 loaded with prefabricated terminal blocks by the first pick-and-place machine 312 to the processing stations 4 arranged along the transport level. The middle row of stator modules, on the other hand, is essentially used as a travel path to bring the rotors 22 with the terminal blocks processed by the processing stations 4 back to the second pick-and-place machine 313.

In the embodiment shown in FIGS. 1A and 1B, three types of processing stations 4 are provided along the transport level. A first group of type 1 processing stations 41 is arranged on the transport level adjacent to the handling device 31 on both sides of the transport level in the area of the shorter additional rows of stator modules. A second group of type 2 processing stations 42 and then a third group of type 3 processing stations 43 are then positioned along both sides of the transport level.

The different types of processing stations 4 stand for the possibility of selecting different procedures depending on the process forces and torques on the workpiece during processing by the tool of the processing station.

For low process forces and torques on the workpiece during processing, a type 1 processing station 41 is used, in which the rotor is held in a floating state when the workpiece is being processed, so that the degrees of freedom of the planar motor may continue to be used to change the positioning of the workpiece during processing. In terminal block production, for example, this procedure may be used to solder contacts on a circuit board.

A type 2 processing station 42 is used for medium process forces and torques on the workpiece during processing. In such a processing station, the rotor may be placed on the stator surface and then processed. In terminal block production, this procedure is used, for example, to contact the lateral communication contacts, which are embodied as spring contacts, and thus load the terminal block software.

A type 3 processing station 43 is used for high process forces and torques on the workpiece during processing. In this type of processing station, the receiving tray with the workpiece may be placed onto a projecting frame of the processing station at an optimum floating height of the rotor. The projecting frame of the processing station may then fully absorb the process forces and torques during workpiece processing. In terminal block production, for example, this procedure may be used to press the housing of the terminal block in a press.

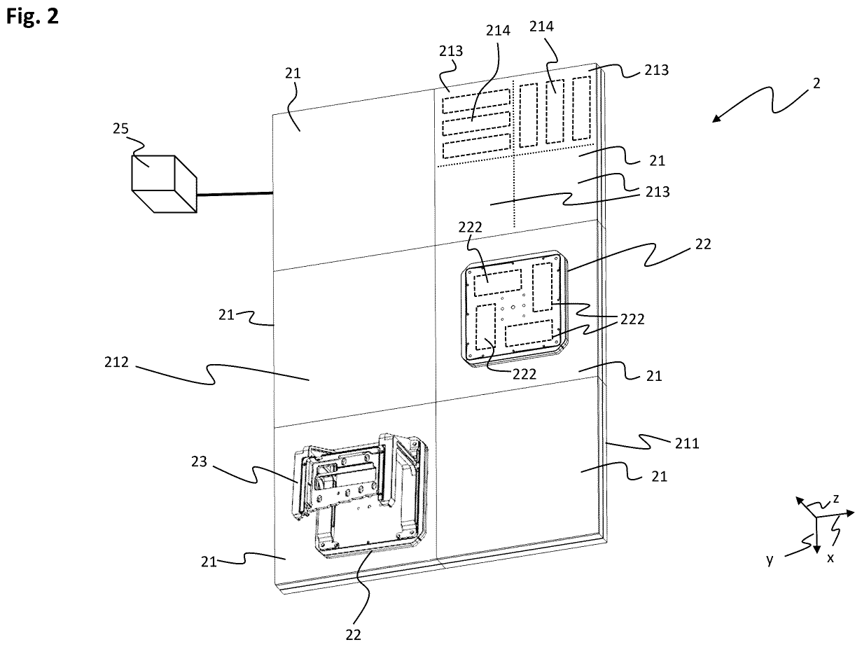

FIG. 2 shows a section of the transport device 2 of the flexible manufacturing system, which is embodied as a planar drive system.

The section in FIG. 2 shows six square stator modules 21, where the six square stator modules form a rectangle consisting of rows of three stator modules each. An additional cover, preferably made of a non-magnetic material, may be provided on the stator surface 212 of the square stator module housing 211. The cover may, for example, serve to protect the stator surface 212 from damage during processing processes.

The stator modules 21 are generally arranged rigidly and fixed in space, so that the stator surfaces 212 of the stator modules 21 form a continuous transport level. FIG. 2 shows a fixed coordinate system with X-axis, Y-axis and Z-axis. The coordinate system is defined in such a way that the transport level lies in the plane spanned by the X-axis and Y-axis.

As the case may be, each stator module 21 may also be assigned its own coordinate system. This is useful, for example, if individual stator modules may be moved in relation to other stator modules. Individual stator modules may be embodied in the form of an elevator, for example, so that they may be moved to different positions and/or between different transport levels. Furthermore, the stator modules may also be embodied to tilt or swivel. Furthermore, the stator modules may also be embodied to be displaceable or translatable in the transport level.

The stator module structure is outlined in the stator module 21 shown above on the right. The stator module 21 consists of four stator assemblies 213, where the four stator assemblies 213 are configured in a square two-by-two arrangement within the stator module 21. Each stator assembly 213 comprises a coil group 214 arranged below the stator surface 212. The coil group 214 comprises three rectangular coils, which are arranged in parallel with regard to one another and the longitudinal extension of which is oriented in parallel with regard to an outer edge of the stator assembly 213. Further coil groups are arranged under the coil group 214 of the stator assembly 213 shown in FIG. 2, where the stacked layers of coil groups each have an orientation rotated by 90° in relation to their longitudinal extent. In the schematic representation of FIG. 2, the different layers of coil groups 214, which each have an orientation rotated by 90°, are shown for illustration purposes in two adjacent stator assemblies 213. The adjacent stator assemblies 213 are identical in their structure and the orientation of the different layers of coil groups 214. The coil groups 214 of the stator assemblies 213 of the stator module 21 form the coil arrangement for generating the stator magnetic field.

The section in FIG. 2 also shows two rotors 22 on the six stator modules 21 shown. As shown in FIG. 2 on one rotor, the permanent magnet arrangement in the plate-shaped square rotor housing 221 is composed of four rectangular permanent magnet units 222 which are arranged in the rotor housing in parallel with regard to the outer edges and form a ring structure.

The stator magnetic field generated by energizing the coil arrangement in the stator modules 21 may interact with the rotor magnetic field of the permanent magnet arrangement of the individual rotors 22 in order to lift the rotor 22 from the transport level and move it across the transport level. In particular, the rotor 22 may be moved in any direction across the transport level in a plane spanned by the X-axis and the Y-axis.

Due to the controlled change in the stator magnetic field, the rotor may not only be moved in parallel with regard to the transport level, i.e. in the direction of the X and Y axes, but a limited movement along the Z axis is also possible, i.e. raising and lowering the rotor, where the air gap between the transport level and the rotor changes. Furthermore, it is also possible to rotate the rotor around the Z-axis, i.e. to yaw, to rotate around the X-axis, i.e. to roll, and/or around to rotate around the Y-axis, i.e. to tilt to a limited extent. The rotors may therefore be moved in the direction of all six rigid body degrees of freedom.

FIG. 2 also schematically shows the controller 25, which is connected to the stator modules 21 in order to output control signals to the stator modules. As shown in FIG. 2, the controller 25 may be connected to a single stator module, which is then embodied to transmit the control signals to the other stator modules in the network. Alternatively, each stator module may also be connected separately to the controller 25

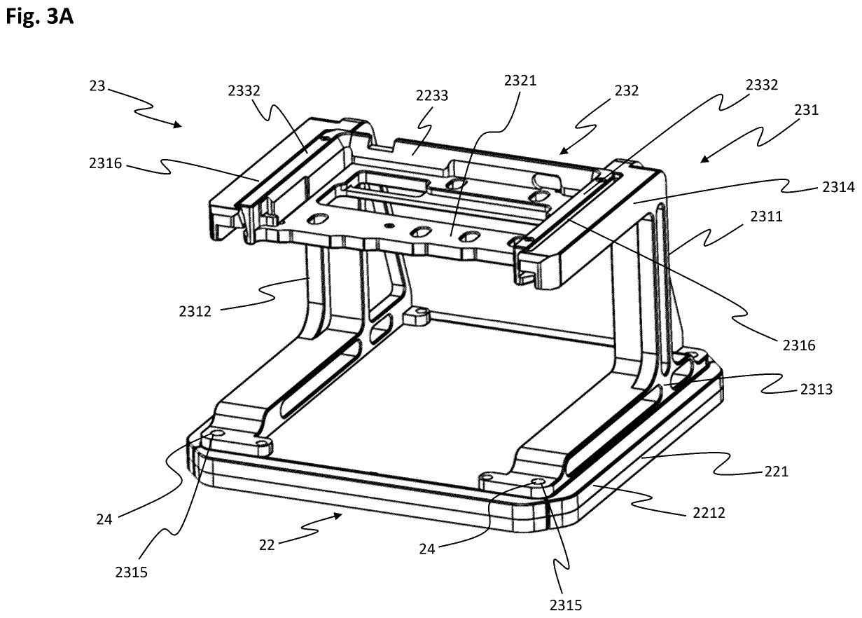

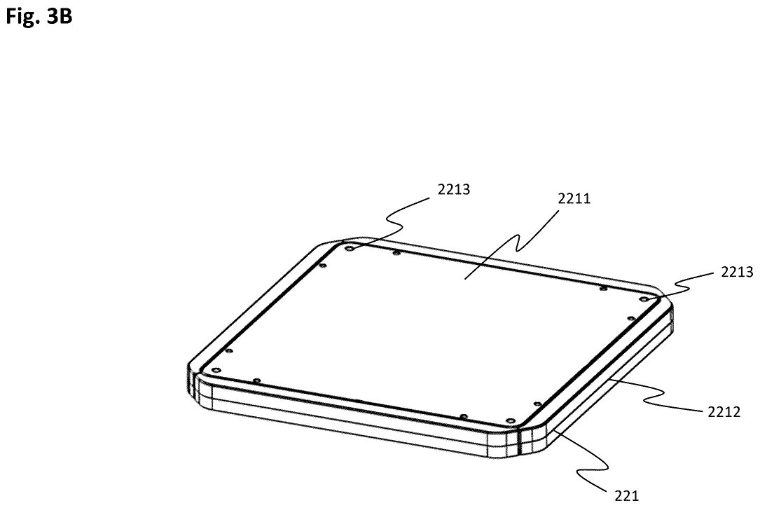

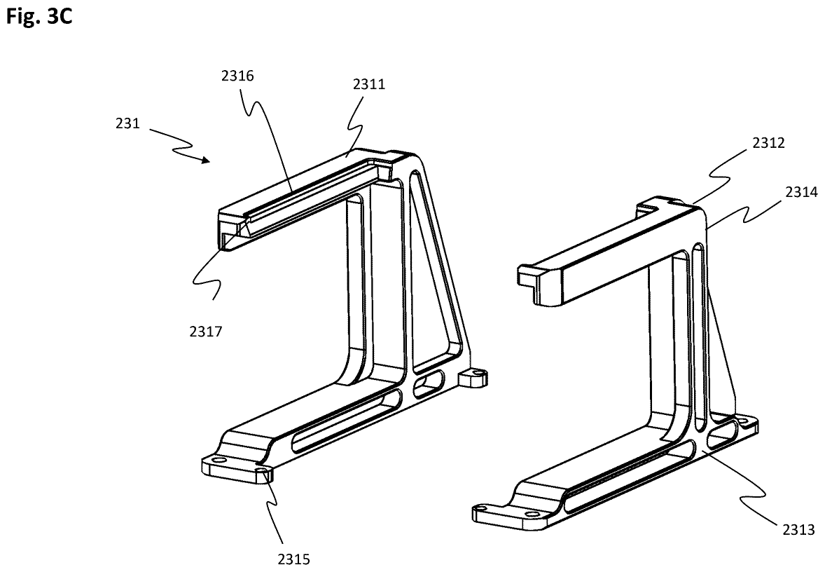

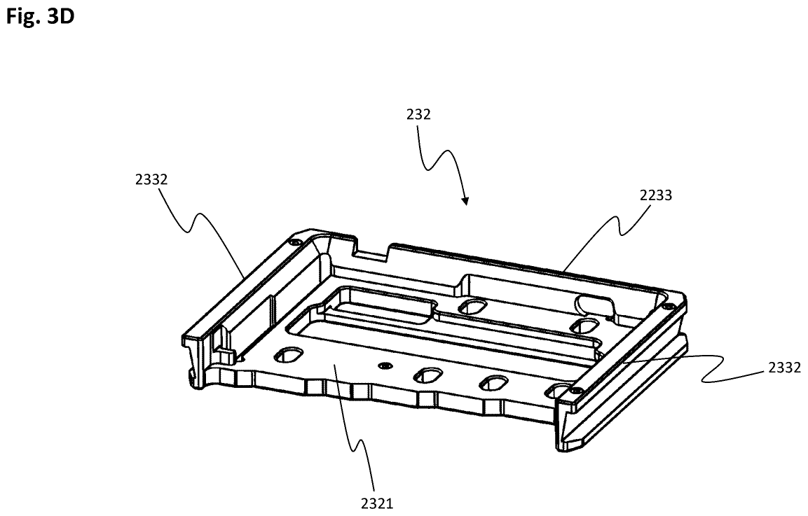

FIGS. 3A-3D show the structure of the rotor 22 including the workpiece holder 23, where FIG. 3A shows a perspective overall view and FIGS. 3B to 3D show the various components separately.

As FIG. 3B shows, the plate-shaped rotor housing 221 comprises a square central body 2211, which comprises bumpers 2212 all around the four outer sides. Bore holes 2213 are provided on the upper side of the plate-shaped central body 2211 along the outer edges to accommodate retaining devices. The retaining devices may be screws, for example, which then engage in internal threads provided in the bore holes 2213. FIG. 3B shows an embodiment with three bore holes 2213 arranged in each of four corner regions. Further bore holes may be provided on the surface of the central body 2211.

The workpiece holder 23 on the rotor 22 is composed of a two-part frame 231, shown in FIG. 3C, and a receiving tray 232, shown in FIG. 3D. The two-part frame 231 may, for example, be made of aluminum or plastic with the aid of injection molding or die casting and comprises a first and a second C-profile support 2311, 2312, which are embodied as mirror images.

As FIG. 3C further shows, the first and second C-profile supports 2311, 2312 may be subdivided into an L-shaped support 2313 and an L-shaped side-piece or “cheek” 2413. The L-shaped support 2313 comprises an elongated base body, which comprises connection lugs with via holes 2315 at both ends. Lateral recesses are provided in the base body to reduce the weight. The L-shaped support also comprises a triangular support projecting from the base body in a rear portion. In the embodiment shown, the first and second C-profile supports 2311, 2312 are each made from a single piece. Alternatively, the C-profile supports may also be assembled from a plurality of parts.

Furthermore, the first arm of the L-shaped cheek 2314 is arranged on the rear portion of the base body of the L-shaped support 2313. The first arm of the L-shaped cheek 2314 is connected to the triangular support of the L-shaped support 2313, where the first arm of the L-shaped cheek 2314 protrudes on the base body of the L-shaped support 2313 with respect to the triangular support. Further lateral recesses for weight reduction are provided in the triangular support of the L-shaped support 2313 and the first arm of the L-shaped cheek.

The second arm of the L-shaped cheek, which is embodied in a beveled manner, extends from an upper section of the triangular support of the L-shaped support 2313 in parallel with regard to the base body of the L-shaped support in the form of a longitudinal beam. On the inner side of the second arm of the L-shaped cheek 2314, an angular longitudinal recess 2316 is embodied in the upper edge region, which extends from a front short section, which forms a boundary 2317, up to the triangular support. On the inside, the second arm of the L-shaped cheek 2314 has a beveled embodiment, with the exception of the area of the angled longitudinal recess 2316. The bevel continues in the upper section of the triangular support adjacent to the second arm of the L-shaped cheek 2314.

As shown in FIG. 3A, the first and second C-section members 2311, 2312 on the square plate-shaped rotor housing 221 are firmly connected to the rotor housing 221 on two opposite sides by screw connections 24 in the via holes 2315 of the connecting lugs of the C-section members, which engage in the holes 2213 provided in the corner region of the rotor housing.

The receiving tray 232 for the workpiece, in the embodiment shown for the terminal block, comprises a base plate 2321 with access openings, as shown in FIG. 3D. The base plate 2321 is delimited on two opposite sides by C-shaped engagements 2332, which are connected to each other on a third side of the base plate 2321 via a rear stop 2233. The internal shape formed by the base plate 2321, the lateral engagements 2332 and the rear stop 2233 corresponds to the external shape of the terminal block housing to be inserted. The C-shaped engagements 2332 and the rear stop 2233 of the receiving tray 232 have a beveled embodiment on the outside between the two engagement arms.

FIG. 3A shows the fully assembled workpiece holder 23 mounted on the rotor housing 221 of the rotor 22. The receiving tray 232 is inserted into the frame 231 between the first and second C-profile supports 2311, 2312, with the two C-shaped engagements 2332 in the region of the longitudinal recesses 2316 of the second arms of the L-shaped cheeks 2314 engaging around the inside of the second arms of the L-shaped cheeks 2314. The upper engagement arm of the C-shaped engagements 2332 of the receiving tray 232 rests in each case on the longitudinal recesses 2316 of the second arms of the L-shaped cheeks 2314 between the front short section of the second arms and the triangular support, where the bevel in the C-shaped engagements 2332 and at the rear stop 2233 abut the bevel on the inside of the second arms of the L-shaped cheek 2314 and on the adjacent upper portions of the triangular support, respectively.

The receiving tray 232 may be removed from the frame 231 between the first and second C-profile supports 2311, 2312 by lifting and pulling it forward, away from the support of the L-shaped support 2313 from the frame 231 of the workpiece holder 23. When the receiving tray 232 is lifted, the upper engagement arms of the C-shaped engagements 2332 each leave the seat in the longitudinal recesses 2316 of the second arms of the L-shaped cheeks 2314 and move upwards until the lower engagement arms of the C-shaped engagements 2332 abut against the underside of the second arms of the L-shaped cheeks 2314.

In the stop position of the lower engagement arms of the C-shaped engagements 2332, the upper engagement arms of the C-shaped engagements 2332 are then located above the upper side of the second arms of the L-shaped cheeks 2314. The receiving tray 232 may then be moved in parallel with regard to the second arm of the L-shaped cheeks 2314 in the direction away from the support of the L-shaped support 2313, with the two C-shaped engagements 2332 engaging around the inner side of the second arms of the L-shaped cheeks. The receiving tray 232 is free when the engagement arms of the C-shaped engagements 2332 are no longer in the region of the second arms of the L-shaped cheeks 2314 of the first and second C-section supports 2311, 2312.

In order to position the receiving tray 232 on the frame 231 of the workpiece holder 23 between the first and second C-profile supports 2311, 2312, the receiving tray 232 is moved in parallel with regard to the second arm of the L-shaped cheeks 2314 in the direction of the support of the L-shaped support 2313, where the engagement arms of the C-shaped engagements 2332 slide over the upper side or lower side of the second arms of the L-shaped cheeks 2314 of the first and second C-profile supports 2311, 2312 until the stop 2233 of the receiving tray 232 has reached the support of the L-shaped support 2313. The two C-shaped engagements 2332 are then located in the area of the longitudinal recesses 2316.

By lowering the receiving tray 232, the upper engagement arms of the C-shaped engagements 2332 are moved downwards until they are seated in the respective angled longitudinal recesses 2316 of the second arms of the L-shaped cheeks 2314. In FIG. 3A, the receiving tray is shown in the lowered position. The bevel on the outside of the C-shaped engagements 2332 and on the rear stop 2233 and the bevel on the second arms of the L-shaped cheeks 2314 and on the adjacent upper portions of the triangular support thereby provide for precise positioning and sufficient clearance during insertion and withdrawal of the receiving tray 232 in the raised position

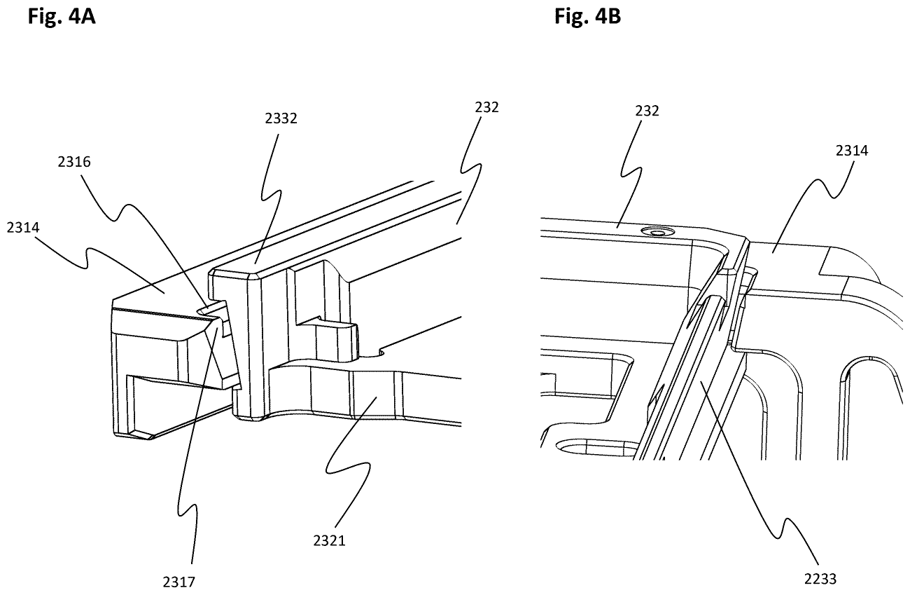

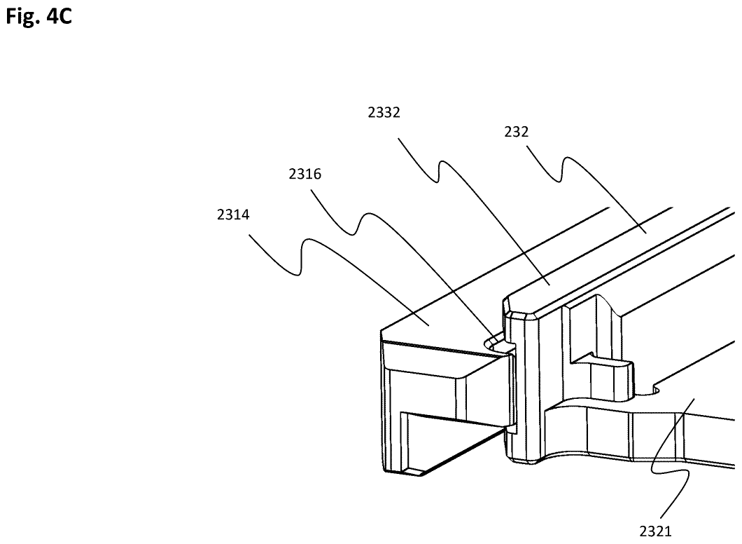

FIG. 4A shows a lateral section and FIG. 4B shows a rear section of the workpiece holder 23 of FIGS. 3A-3D, enlarged during the positioning of the receiving tray 232 on the second arms of the L-shaped cheeks 2314 serving as longitudinal supports. The receiving tray 232 is raised in order to be pulled off the second arm of the L-shaped cheeks 2314 or pushed onto the second arm of the L-shaped cheeks 2314. Due to the bevel on the outside of the C-shaped engagements 2332 and the bevel on the second arms of the L-shaped cheeks 2314, the receiving tray 232 automatically moves onto the second arm of the L-shaped cheeks 2314 when the receiving tray 232 is lowered into the intended position in order to fix the receiving tray 232 laterally. At the same time, when lowering the receiving tray, the interaction of the bevel on the rear stop 2233 of the receiving tray and the bevel on the upper section of the triangular support of the first C-profile support 2311 and the second C-profile support s 2312, the C-shaped engagements 2332 of the receiving tray 232 in the longitudinal recesses 2316 on the second arms of the L-shaped cheeks 2314 are each pushed against the boundary 2317 defining the longitudinal recess 2316, so that the receiving tray 232 is also fixed in the forward-backward direction.

FIG. 4C shows an alternative embodiment in which the bevel below the longitudinal recess 2316 of the second arms of the L-shaped cheeks 2314 is dispensed with. Accordingly, the bevel on the outside of the C-shaped engagements 2332 of the receiving tray 232 is dispensed with, as well.

The workpiece transported by the rotor may be of any shape. Examples of workpieces that may be transported with the rotor and processed in a processing station include electronic components such as the terminal block mentioned above, components for microcomputers, cell phones etc., workpieces may also be components from a manufacturing process such as screws, bearings etc., liquid containers such as bottles, cans, test tubes etc., medicines or food.

In order to process the workpiece arranged on the rotor, processing stations are arranged at one edge along the transport level, as shown in FIGS. 1A and 1B. The processing station comprises a base body that is arranged adjacent to a stator module and is preferably mounted independently of the stator module. A tool is movably arranged on the base body, with the aid of which the workpiece may be processed. The processing station may carry out any process engineering and/or production engineering processing. Processing stations may be stations for mechanical processing such as drilling, milling, cutting, etc., stations for assembling components with joining techniques such as terminal blocking, pressing, pulling, screwing, welding, gluing, etc., or stations for procedural processes such as filling, mixing, cleaning, etc., or stations for electrical contacting, electrical testing, programming of integrated circuits, etc.

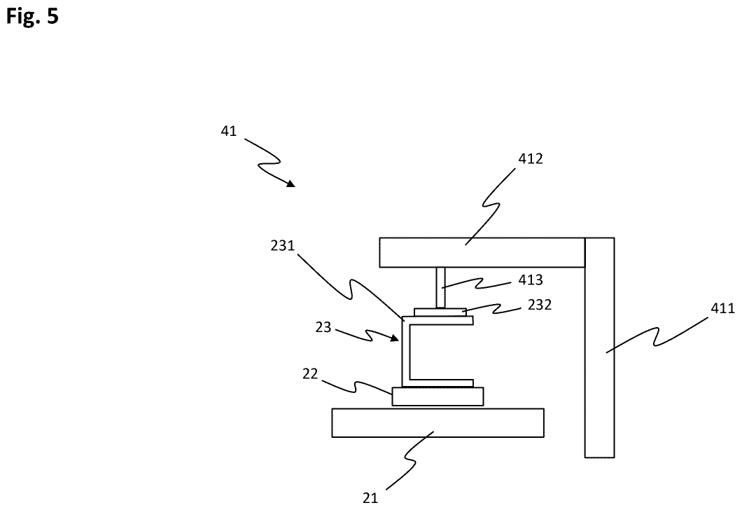

FIG. 5 shows a schematic cross-section of a type 1 processing station 41 comprising a base body 411 having an arm 412 on which a tool 413 is arranged. The rotor 22 with the workpiece holder 23, in which the frame 231 carries the receiving tray 232 with the workpiece, hovers above the stator module 21 while the tool 413 of the type 1 processing station 41 processes the workpiece in the receiving tray 232 of the workpiece holder 23.

The rotor 22 is still fully movable in the suspended state during processing, so that the rotor 22 may be continuously repositioned. This may be used in order to support the processing process by using the rotor movement to move the workpiece through the tool for processing. It is possible to process the workpiece while the rotor is suspended if low process forces and torques act upon the workpiece during processing with the aid the tool of the processing station.

A type 1 processing station, in which the workpiece is processed with a floating rotor, may be a soldering station in terminal block production, for example, in which soldering contacts are made on the terminal block. During the soldering process in the type 1 processing station, the floating rotor 22 may be moved in relation to the soldering tool in such a way that different contacts are positioned on the terminal block under the soldering tool one after the other.

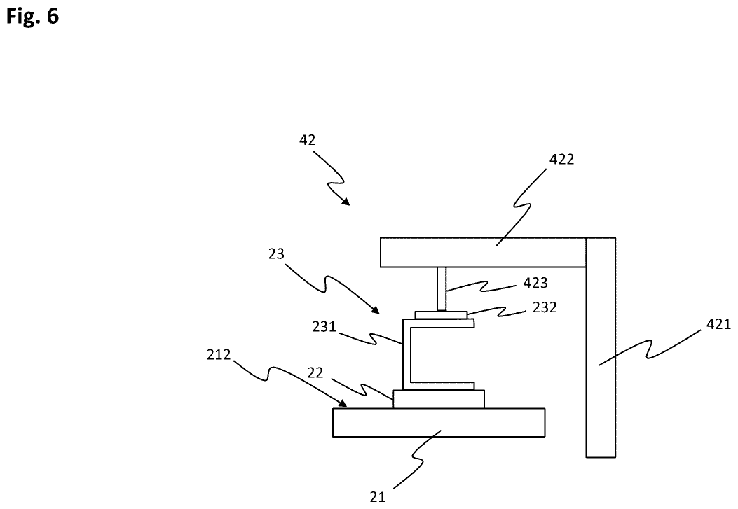

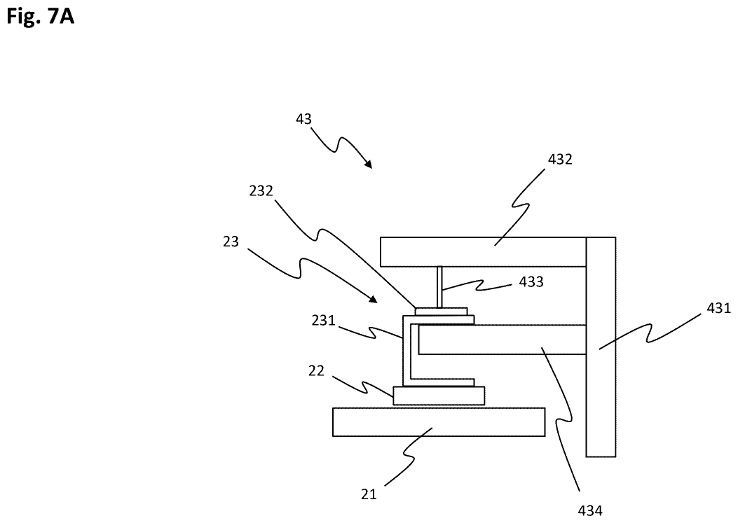

FIG. 6 shows a schematic cross-section of a type 2 processing station 42, in which the rotor 22 with the workpiece holder 23, in which the frame 231 carries the holder 232 with the workpiece, is set down on the stator surface 212 during the processing process. In its structure, the type 2 processing station 42 corresponds to the type 1 processing station 41 and comprises a second base body 421 with a second arm 422, on which a second tool 423 is arranged.

The rotor 22 with the workpiece holder 23, the receiving tray 232 of which contains the workpiece, is positioned below the tool 423. The rotor 22 is then set down on the stator surface 212 by a corresponding motion controller in order to process the workpiece in the receiving tray 232 with the aid of the tool. Type 2 processing stations are used for medium process forces and torques, in which the planar motor forces and torques are not sufficient to always compensate for the loads occurring on the rotor during processing of the workpiece and thus prevent the rotor from unintentionally striking the stator surface and damaging it.

A type 2 processing station in terminal block production may, for example, be a contacting station in which the lateral communication contacts of the terminal block, which are embodied as spring contacts, are contacted in order to load the corresponding software.

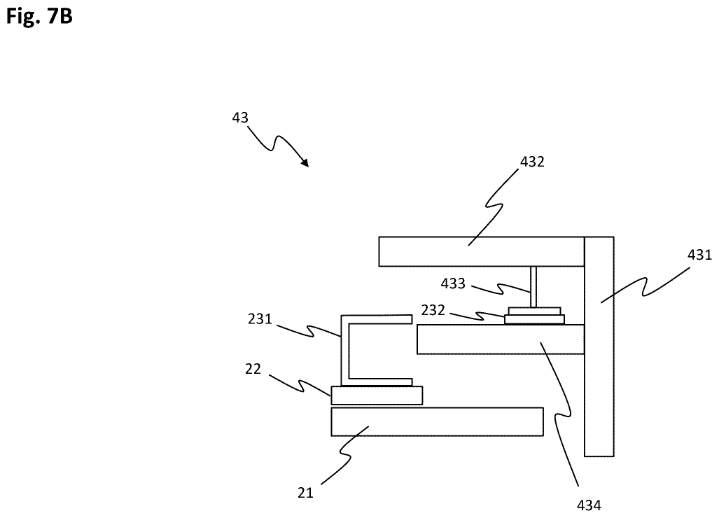

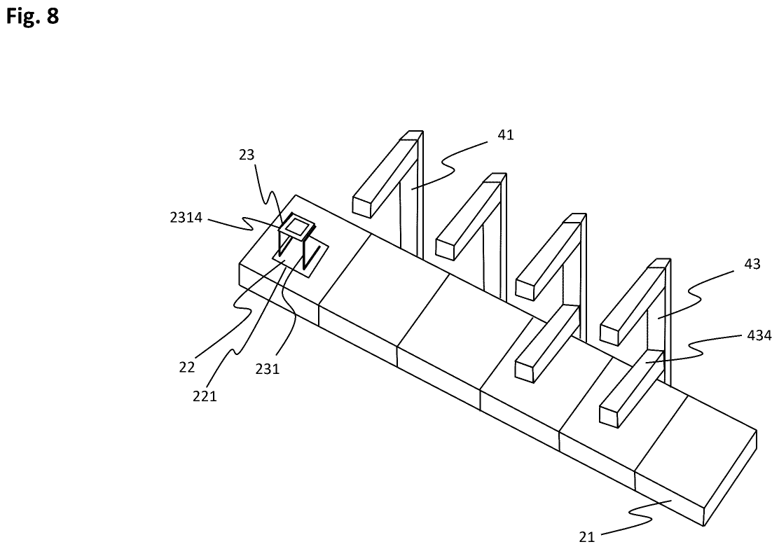

FIG. 7A shows a first embodiment of a type 3 processing station 43 schematically in cross-section, where in addition to a third base body 431 and a third arm 432 having a third tool 433, which are also provided in the type 1 processing station 41 or type 2 processing station 42, a projecting frame 434 is arranged on the third base body 431. The projecting frame 434 of the type 3 processing station 43 serves to support the receiving tray 232 with the workpiece after the rotor 22 with the tool holder 23 has moved into the desired position. It is also possible that another part of the tool holder 23 is supported by the projecting frame 434 of the type-3 processing station 43, such as the second arm of the L-shaped cheek 2314.

For this purpose, the rotor 22 is controlled in such a way that the floating level of the rotor makes it possible to move the receiving tray 232 with the workpiece above the projecting frame 434 of the type 3 processing station 43 until the takeover position of the receiving tray 232 above the projecting frame 434, in which the workpiece in the receiving tray 232 is then to be processed by the tool 433, is reached. The rotor 23 is then lowered until the projecting frame 434 supports the receiving tray 232 with the workpiece. Alternatively, the projecting frame 434 of the type 3 processing station 43 may also be raised until the projecting frame 434 supports the receiving tray 232.

In the support position, when the projecting frame 434 of the type 3 processing station 43 engages with the receiving tray 232, the receiving tray 232 lifts from the second arms of the L-shaped cheeks 2314, where the upper engagement arms of the C-shaped engagements 2332 of the receiving tray 232 move out of the longitudinal recesses 2316 of the second arms of the L-shaped cheeks 2314, as described with reference to the two embodiments of the workpiece holder 23 described above in FIGS. 4A and 4B, respectively. If the upper engagement arms of the C-shaped engagements 2332 are then located above the upper side of the second arms of the L-shaped cheek 2314, the receiving tray 232 may be separated from the frame 231 of the workpiece holder 23 by moving out the rotor 22. It is also possible to process the workpiece if the rotor 22 does not move out and the receiving tray 232 remains in the workpiece holder 23. In this case, as well, the process forces may be efficiently absorbed by the projecting frame 434.

After processing the workpiece, the frame 231 of the workpiece holder 23 of the rotor 22 may then pick up the receiving tray 232 with the processed workpiece again by proceeding in reverse order.

The projecting frame 434 of the type 3 processing station 43 may also fully absorb high process forces and torques during workpiece processing in the support position of the receiving tray, which could damage the stator surface 212 in the case of an offset rotor as in the type 2 processing station 42.

In the context of terminal block production, such a type 3 processing station may, for example, be a press with the aid of which the housing of the terminal block is pressed.

As an alternative to the embodiment of the type 3 processing station 43 shown in FIG. 7A, a further embodiment of the type 3 processing station 43 is shown in FIG. 7B, in which the projecting frame 434 is embodied to move the receiving tray 232 with the workpiece in the type 3 processing station on the projecting frame 434 or to feed the receiving tray 232 with the workpiece into the type 3 processing station 43. FIG. 7B again shows this embodiment in schematic form in cross-section.

The workpiece processing procedure is carried out in such a way that the rotor 22 with the workpiece holder 23 is moved towards the type 3 processing station 43 at a floating level in such a way that the receiving tray 232 with the workpiece lies above the projecting frame 434, the rotor 22 being advanced with the C-shaped profile supports 2311, 2312 of the frame 231 of the workpiece holder 23 over the projecting frame 434 until the takeover position of the receiving tray 232 is reached.

The rotor 22 is then lowered in such a way that the projecting frame 434 of the type 3 processing station 43 comes into engagement with the receiving tray 232. The floating level of the rotor 22 is thereby changed in such a way that the projecting frame 434 raises the receiving tray 232 and the upper engagement arms of the C-shaped engagements 2332 of the receiving tray 232 move out of the longitudinal recesses 2316 of the second arms of the L-shaped cheeks 2314, until the upper engagement arms of the C-shaped engagements 2332 are above the top of the second arms of the L-shaped cheek 2314. Alternatively, the receiving tray 232 may be lifted by the projecting frame 434 of the type 3 processing station 43 until the projecting frame 434 has moved the receiving tray 232 to the position described above.

In this position, the receiving tray 232 may then be removed from the frame 231 of the workpiece holder 23 by pulling the C-shaped engagements 2332 of the receiving tray 232 from the second arms of the L-shaped cheeks 214 of the frame 231 of the workpiece holder 23 with the aid of the projecting frame 434 of the type 3 processing station 43.

A guide structure, for example a roller guide, may further be provided in the projecting frame 434 of the type-3 processing station 43, which comes into engagement with the workpiece carrier 23 in order to hold the rotor 22 in position during the transfer of the receiving tray 232. Subsequently, as shown in FIG. 7B, the rotor 22 may then also be moved to a waiting position in front of the projecting frame 434 of the type 3 processing station 43.

By proceeding in reverse order after the workpiece has been processed, the frame 231 of the workpiece holder 23 of the rotor 22 may again pick up the receiving tray 232 with the processed workpiece.

In terminal block production, for example, the type 3 processing station may be used to simultaneously contact and test the electrical contacts of the terminal block in the processing station.

FIG. 8 shows the possibility of moving the rotor 22 with the workpiece holder 23, which comprises the frame 231 with two C-shaped profile supports 2311, 2312, along a straight transport path on the transport level, even if obstacles such as the projecting frame 434 of the type 3 processing stations 43 are located above the transport path formed by the stator modules 21.

FIG. 8 shows a schematic depiction of a transport level having five stator modules 21 arranged in series, along which two type 1 processing stations and then two type 3 processing stations with projecting frames 434 are provided. By adjusting the floating level of the rotor 22 accordingly, the workpiece holder 23 may be positioned in such a way that, when the rotor in FIG. 8 is moved over the five stator modules 21 arranged in series, the projecting frames 434 of the two type 3 processing stations are always located in the area between the rotor housing 221 and the second arms of the L-shaped cheeks 2314 of the frame 231, but without coming into contact with the first arms of the L-shaped cheeks 2314.

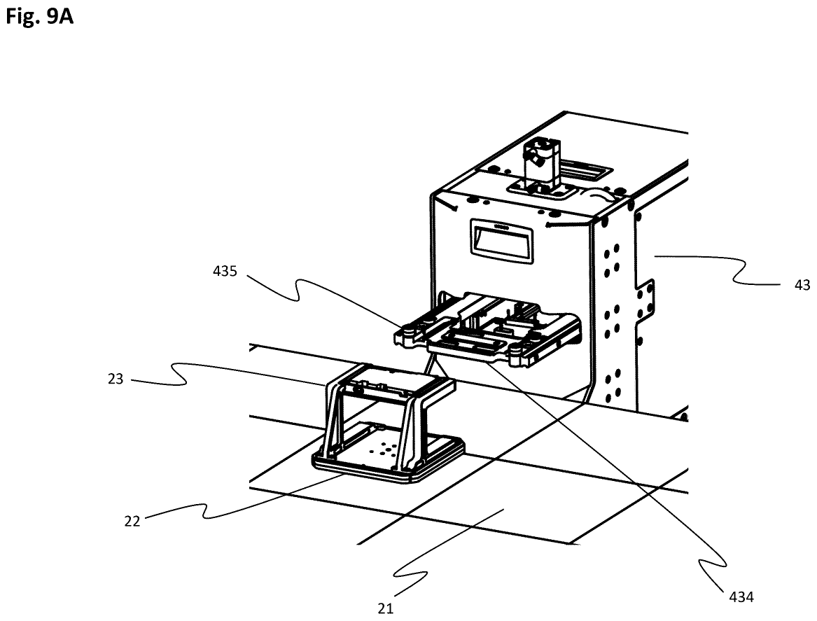

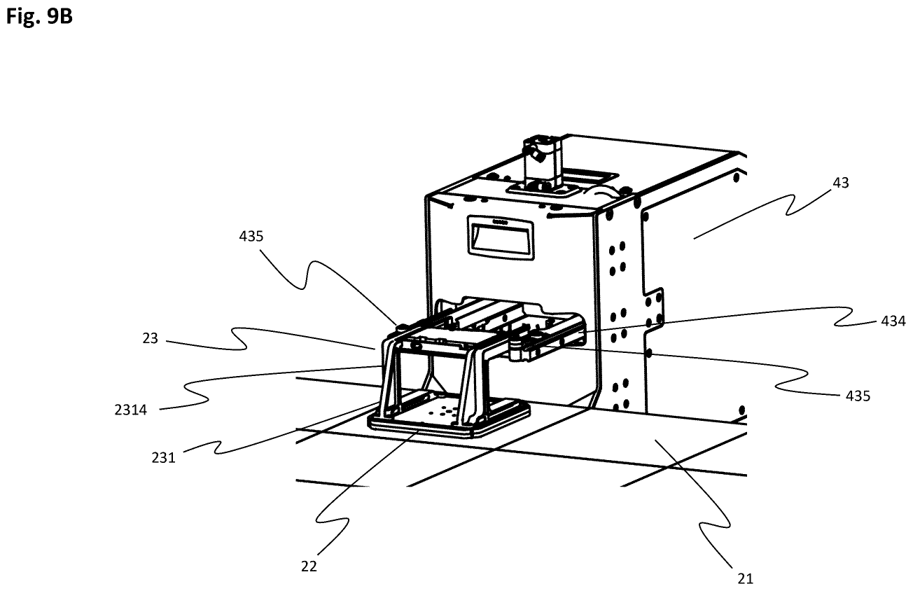

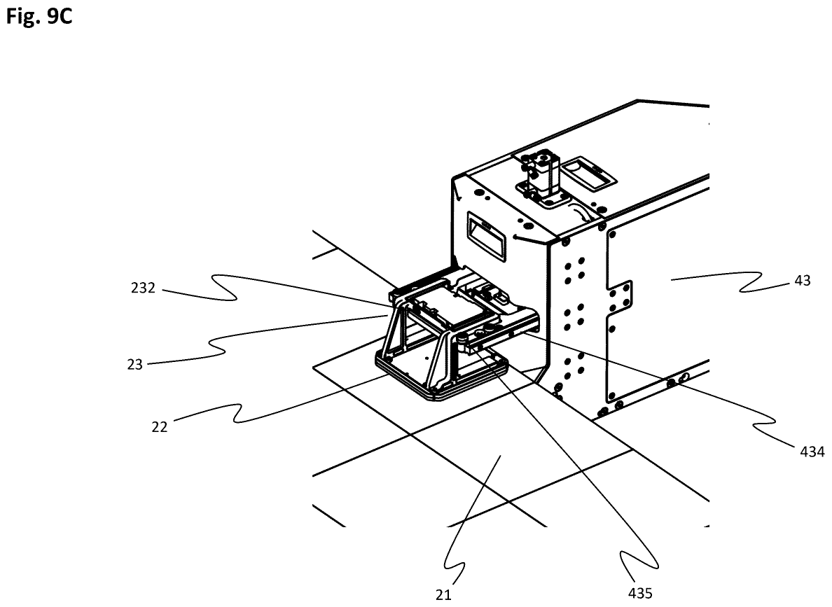

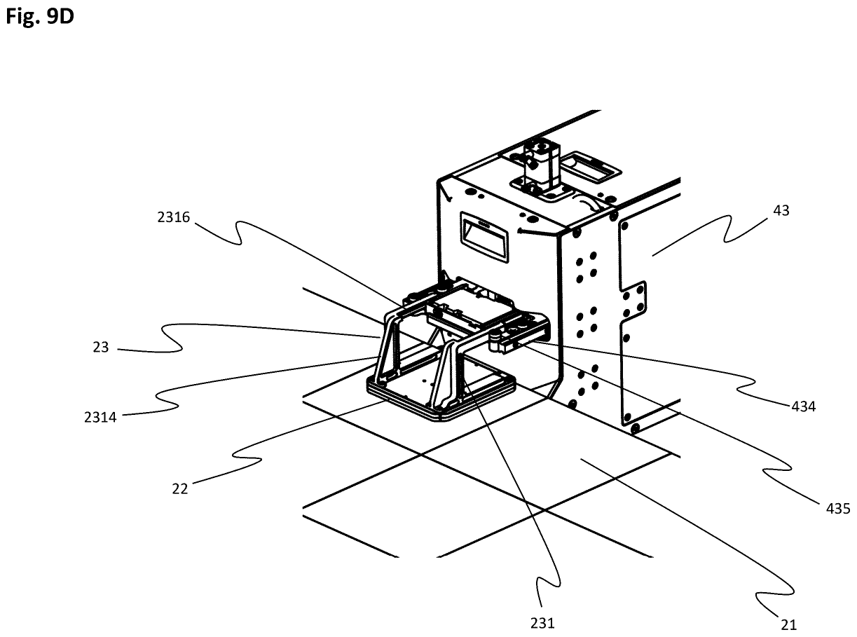

FIGS. 9A-9D show a processing procedure for terminal block production with a type 3 processing station 43, in which the terminal block is fed into the processing station. FIGS. 9A to 9D show successively recorded snapshots of the sequence in which the terminal block is moved from the rotor 22 with the workpiece holder 23 to the type 3 processing station 43, then the processing process is carried out and then the terminal block is moved away from the rotor again by the type 3 processing station.

FIG. 9A shows the rotor 22 approaching the type 3 processing station 43, which comprises a projecting frame 434 having two arms, each of which carries a lateral roller guide 435 on the inside.

FIG. 9B then shows, as a next snapshot, how the second arms of the L-shaped cheek 2314 of the frame 231 of the workpiece holder 23 on the rotor 22 come into engagement with the projecting frame 343 of the type-3 processing station 43. In this context, the two outer sides of the second arms of the L-shaped cheeks 2314 are guided by the rollers of the lateral roller guide 435 on the inner side of the arms of the projecting frame 434 of the type 3 processing station 43, which results in improved positioning when the workpiece holder 23 on the rotor 22 is further retracted into the projecting frame 231.

FIG. 9C then shows a top view of the rotor 22 when the workpiece holder 23 is retracted between the arms of the projecting frame 434 of the type 3 processing station 43 in such a way that a takeover position of the receiving tray 232 is reached. The projecting frame 434 is embodied in such a way that, in the takeover position, frame elements of the projecting frame 434 may engage or be brought into engagement with the receiving tray 232 in order to fix the receiving tray 232 with the terminal block.

Subsequently, as shown in FIG. 9D, the projecting frame 434 may be retracted into the Type 3 processing station 43 so that the C-shaped engagements of the receiving tray are withdrawn from the second arms of the L-shaped cheeks 2314.

Once the terminal block has been processed in the type 3 processing station, the rotor 22 may then pick up the receiving tray 232 again in the reverse direction using the workpiece holder 23. The rotor 22 may then return the processed terminal block to other processing stations or to the handling device.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
List of reference numerals

| | |
|---|---|
| 1 Manufacturing platform | 25 Controller |
| 2 Transport device | 24 Screw connection |
| 21 Stator module | 3 Workpiece storage |
| 211 Stator module housing | 31 Handling device |
| 212 Stator surface | 311 Supporting frame |
| 213 Stator assembly | 312 First pick and place machine |
| 214 Coil group | 313 Second pick and place machine |
| 22 Rotor | 32 First transport carrier |
| 221 Rotor housing | 33 Second transport carrier |
| 2211 Central body | 34 Workpiece container |
| 2212 Bumper | 4 Processing station |
| 2213 Bore hole | 41 Type 1 processing station/ |
| | contacting station |
| 222 Permanent magnet assembly | 411 Base body |
| 23 Workpiece holder | 412 Arm |
| 231 Frame | 413 Tool |
| 2311 First C-profile carrier | 42 Type 2 processing station/ |
| | soldering station |
| 2312 Second C-profile carrier | 421 Second base body |
| 2313 Support | 422 Second arm |
| 2314 Cheek | 423 Second tool |
| 2315 Via holes | 43 Type 3 processing |
| | station/press |
| 2316 Longitudinal recess | 431 Third base body |
| 2317 Delimitation | 432 Third arm |
| 232 Receiving tray | 433 Third tool |
| 2321 Base plate | 434 Projecting frame |
| 2332 Engagement | 435 Roller guide |
| 2233 Rear stop | |

What is claimed is:

1. A flexible manufacturing system comprising:
a manufacturing platform on which a transport device and a plurality of processing stations are arranged, and
a controller;
wherein the transport device comprises a plurality of stator modules and at least one rotor for transporting workpieces,
wherein each stator module comprises a stator module housing having a stator surface and a coil arrangement arranged below the stator surface for generating a stator magnetic field,
wherein the rotor comprises a plate-shaped rotor housing having a permanent magnet arrangement for generating a rotor magnetic field and a workpiece holder arranged on the rotor housing,
wherein the workpiece holder comprises a frame having two L-shaped cheeks and a receiving tray having an inner shape for inserting a workpiece,
wherein each L-shaped cheek comprises a first arm for fastening to the plate-shaped rotor housing and a second arm projecting from the first arm and oriented substantially in parallel with regard to the plate-shaped rotor housing, and
wherein the second arms of the L-shaped cheeks each comprise opposite longitudinal recesses for laterally supporting the receiving tray;
wherein the plurality of stator modules on the manufacturing platform comprise a compound structure having a transport level formed by the stator surfaces for linking the processing stations arranged adjacent to the transport level,
wherein the controller is configured to output control signals to the network of the plurality of stator modules and the stator modules are configured to energize the coil groups of the associated stator assemblies in accordance with the control signals to move the rotor on the transport level to the processing stations, and
wherein the rotor is moveable above the transport level in a first direction and/or a second direction and/or a third direction via interaction of the stator field and the rotor magnetic field, wherein the first direction and the second direction are oriented in parallel with regard to the transport level and the third direction is oriented perpendicular with regard to the transport level;
wherein each processing station comprises a tool for processing the workpiece in the receiving tray of the workpiece holder of the rotor,
wherein at least one processing station comprises a frame projecting beyond the transport level for depositing the receiving tray of the workpiece holder of the rotor, and
wherein the controller is configured to move the rotor with a workpiece located in the receiving tray via control signals on the network of the plurality of stator modules during the processing of the workpiece at the processing station with the projecting frame such that the projecting frame of the processing station engages with the receiving tray supported by the second arms of the L-shaped cheeks of the frame of the workpiece holder in order to lift the receiving tray out of the longitudinal recesses of the second arms of the L-shaped cheeks of the frame of the workpiece holder before the processing of the workpiece with the tool of the processing station.

2. The flexible manufacturing system according to claim 1, wherein the controller is configured to move the rotor with the workpiece holder and the workpiece located in the receiving tray via control signals on the composite of the plurality of stator modules such that the rotor is guided laterally past the processing station having the frame projecting above the transport level, the projecting frame projecting into the free space between the rotor housing and the receiving tray supported laterally by the workpiece holder.

3. The flexible manufacturing system according to claim 1, wherein the controller is configured to keep the rotor in a floating state when the workpiece is processed in the receiving tray by the tool of the processing station.

4. The flexible manufacturing system according to claim 1, wherein the controller is configured to place the rotor onto the stator surface before processing the workpiece in the receiving tray with the tool of the processing station.

5. The flexible manufacturing system according to claim 1, wherein the controller is configured to place the frame and/or the receiving tray of the workpiece holder onto the projecting frame of the processing station before processing the workpiece by lowering the rotor above the projecting frame.

6. The flexible manufacturing system according to claim 5, wherein the projecting frame of the processing station is configured to move the deposited receiving tray.

7. The flexible manufacturing system according to claim 1, wherein a workpiece storage is provided on the manufacturing platform, which comprises a handling device for transferring the workpiece from the workpiece storage into the receiving tray or for transferring the workpiece from the receiving tray into the workpiece storage.

8. A rotor for a flexible manufacturing system including a transport device having a plurality of stator modules and at least one such rotor for transporting workpieces, the rotor comprising:
a plate-shaped rotor housing with a permanent magnet arrangement for generating a rotor magnetic field, and
a workpiece holder arranged at the rotor housing;
wherein the workpiece holder includes a frame having two L-shaped cheeks and a receiving tray having an interior shape for inserting a workpiece,
wherein each L-shaped cheek comprises a first arm for fastening on the plate-shaped rotor housing and a second arm projecting from the first arm, the second arm being essentially aligned in parallel with regard to the plate-shaped rotor housing, and
wherein the second arms of the L-shaped cheeks each comprise longitudinal recesses for lateral support of the receiving tray on opposite sides of each other.

9. The rotor according to claim 8, wherein the frame of the workpiece holder comprises a first and a second C-profile carrier, which are configured as mirror images.

10. The rotor according to claim 9, wherein:
the first and second C-profile carriers each have a longitudinal beam, wherein an angular longitudinal recess is configured on an inside of the longitudinal beam in the upper edge region, and
the receiving tray having C-shaped engagements on two opposite sides, the upper engagement arm of the C-shaped engagement being configured to engage in an angled longitudinal recess on the inside of the longitudinal member.

11. The rotor according to claim 10, wherein bevels are provided on the inside of the longitudinal beam at least below the longitudinal recess and on the outside of the C-shaped engagements of the receiving tray.

12. A processing station for a flexible manufacturing system having a manufacturing platform on which a transport device and a plurality of such processing stations are arranged, wherein:
the transport device comprises a plurality of stator modules and at least one rotor for transporting workpieces, and
wherein the plurality of stator modules comprise a compound structure having a transport level formed by the stator surfaces for linking the processing stations arranged adjacent to the transport level;
the processing station comprising:
a tool for processing a workpiece in a receiving tray of a workpiece holder of the rotor, and
a frame projecting beyond a transport level for depositing the receiving tray of the workpiece holder of the rotor.

13. The processing station according to claim 12, wherein the frame of the processing station is configured to move the deposited receiving tray.

14. The processing station according to claim 12, wherein the frame comprises a guide structure, which engages with the workpiece holder of the rotor and forces the rotor into a correct position.

15. The processing station according to claim 12, wherein the guide structure of the frame is a roller guide.
